(19) United States
(12) Patent Application Publication
(10) Pub. No.: US 2017/0018009 A1
(43) Pub. Date: Jan. 19, 2017

(54) Bidding Systems and Methods For Minimizing The Cost Of Field Experiments Using Advertisement Exchanges

(71) Applicant: Yahoo! Inc., Sunnyvale, CA (US)

(72) Inventor: Ayman FARAHAT, San Francisco, CA (US)

(73) Assignee: Yahoo! Inc., Sunnyvale, CA (US)

(21) Appl. No.: 14/798,090

(22) Filed: Jul. 13, 2015

(51) Int. Cl. G06Q 30/02

(52) U.S. Cl. CPC G06Q 30/0275

(57) ABSTRACT

Systems and methods are provided for minimizing the cost of field experiments using advertisement exchanges. The system includes circuitry configured to obtain a bidding opportunity to deliver a message from an exchange system, where the bidding opportunity comprises an impression candidate and user information associated with the impression candidate. The system includes circuitry configured to obtain at least one bidding parameters from the database, where the at least one bidding parameters indicates a target audience of the message. The system includes circuitry configured to assign a random bid amount to the bidding opportunity based on the at least one bidding parameters, where the random bid amount at least partially indicates a treatment intensity of the message.

### BACKGROUND

The Internet is a ubiquitous medium of communication in most parts of the world. The emergence of the Internet has opened a new forum for the creation and placement of advertisements (ads) promoting products, services, and brands. Internet content providers rely on advertising revenue to drive the production of free or low cost content. Advertisers, in turn, increasingly view Internet content portals and online publications as a critically important medium for the placement of advertisements. Mobile advertising is a form of advertising via mobile (wireless) phones or other mobile devices. Mobile advertising are closely related to online or internet advertising, though its reach is far greater.

It is desirable for an advertiser to know whether an advertising campaign is delivering the desired results: who it's reaching, how it's resonating, and consumers' reaction across different platforms. Platforms include advertising tailored for mobile devices, advertising tailored for desktop computers and other specific formats and delivery channels. There are different ways to measure the advertising effectiveness. One of the conventional ways to measure advertising effectiveness is to implement randomized field experiments. The typical setting is to preselect a set of users to see the ad (test) and another set of users to see a control ad placebo. However, randomized field experiments for measuring advertising effectiveness are limited by at least two factors. First, there is the cost of showing placebo ads to the control group. Second, there is the representativeness of the treated and control groups both on observed and unobserved covariates.

Thus, there is a need to develop methods and systems to help advertisers to measure advertising effectiveness with reduced cost and improved accuracy.

### SUMMARY

Different from conventional solutions, the disclosed system solves the above problem by adopting a bidding system for minimizing the cost of field experiments using advertisement exchanges.

In a first aspect, the embodiments disclose a computer system that includes a processor and a non-transitory storage medium accessible to the processor. The system includes circuitry configured to obtain a bidding opportunity to deliver a message from an exchange system, where the bidding opportunity includes an impression candidate and user information associated with the impression candidate. The system includes circuitry configured to obtain at least one bidding parameters from the database, where the at least one bidding parameters indicates a target audience of the message. The system includes circuitry configured to assign a random bid amount to the bidding opportunity based on the at least one bidding parameters, where the random bid amount at least partially indicates a treatment intensity of the message.

In a second aspect, the embodiments disclose a computer implemented method by a system that includes one or more devices having a processor. In the computer implemented method, the system obtains a bidding opportunity to deliver a message from an exchange system, where the bidding opportunity includes an impression candidate and user information associated with the impression candidate. The system obtains at least one bidding parameters from a database, where the at least one bidding parameters indicates a target audience of the message. The system assigns a random bid amount to the bidding opportunity based on the at least one bidding parameters, where the random bid amount at least partially indicates a treatment intensity of the message.

In a third aspect, the embodiments disclose a non-transitory storage medium configured to store a set of instructions. The non-transitory storage medium includes instructions executable to obtain a bidding opportunity to deliver a message from an exchange system, where the bidding opportunity includes an impression candidate and user information associated with the impression candidate. The non-transitory storage medium further includes instructions executable to obtain at least one bidding parameters for an advertiser from a database, where the at least one bidding parameters indicates a target audience of the message. The non-transitory storage medium includes instructions executable to assign a random bid amount to the bidding opportunity based on the at least one bidding parameters in a manner such that the random bid amount is correlated with treatment intensity of an advertisement in the message and the random bid amount is not correlated with unobserved user features correlated with the treatment intensity. The non-transitory storage medium includes instructions executable to use the random bid amount to estimate advertisement treatment effect within a regression model.

### BRIEF DESCRIPTION OF THE DRAWINGS

FIG. 1 is a block diagram of an example environment in which a computer system according to embodiments of the disclosure may operate;

FIG. 2 illustrates an example computing device in the computer system;

FIG. 3 illustrates an example embodiment of a server computer for a bidding system;

FIG. 4 is an example block diagram illustrating embodiments of the non-transitory storage of the server computer;

FIG. 5 is an example block diagram illustrating embodiments of the non-transitory storage of the server computer;

FIG. 6 is an example flow diagram illustrating embodiments of the disclosure;

FIG. 7 is an example flow diagram illustrating embodiments of the disclosure;

FIG. 8 is an example block diagram illustrating embodiments of the disclosure; and

FIG. 9 is an example block diagram illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

A mobile app may refer to a mobile application, which includes a computer program designed to run on mobile devices including smartphones, tablet computers, smart watches, and etc.

While the publisher and social networks collect more and more user data through different types of e-commerce applications, news applications, games, social networks applications, and other mobile applications on different mobile devices, a user may by tagged with different features accordingly. Using these different tagged features, online advertising providers may create more and more audience segments to meet the different targeting goals of different advertisers.

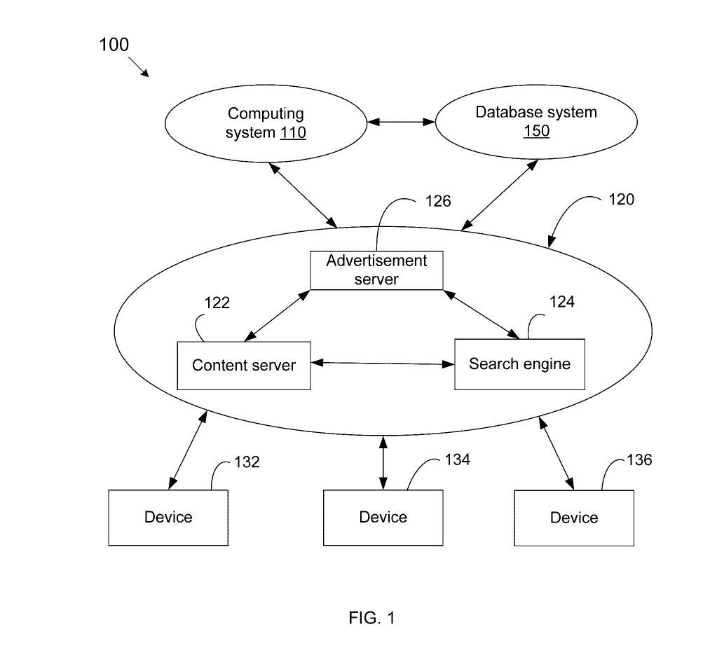

FIG. 1 is a block diagram of an environment 100 in which a computer system according to embodiments of the disclosure may operate. However, it should be appreciated that the systems and methods described below are not limited to use with the particular exemplary environment 100 shown in FIG. 1 but may be extended to a wide variety of implementations.

The environment 100 may include a computing system 110 and a connected server system 120 including a content server 122, a search engine 124, and an advertisement server 126. The computing system 110 may include a cloud computing environment or other computer servers. The server system 120 may include additional servers for additional computing or service purposes. For example, the server system 120 may include servers for social networks, online shopping sites, and any other online services.

The content server 122 may be a computer, a server, or any other computing device or circuitry known in the art, or the content server 122 may be a computer program, instructions, and/or software code stored on a computer-readable storage medium that runs on a processor or other circuitry of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device or circuitry known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more computer servers, or any other circuitry or computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser. The advertisement server 126 may include computer servers for providing ads to different platforms and websites.

The computing system 110 and the connected server system 120 have access to a database system 150. The database system 150 may include memory such as disk memory or semiconductor memory to implement one or more databases. At least one of the databases in the database system may be a campaign database that stores information related to a plurality of campaign delivery feeds. The campaign delivery feeds may include impressions, conversions, video views, or other events performed on the marketing message.

Processing the data that forms the campaign delivery feeds creates a substantial technical problem that must be addressed. The campaign delivery feeds are generally created near real time right after the events are performed. Generally, near real time corresponds to the actual time during which a process or event occurs For example, a publisher like Yahoo! may generate millions of campaign delivery feeds per minute and the data size of the campaign delivery feeds may be greater than one gigabytes during one second. This volume of data is more data than can reasonably be processed by conventional data processing equipment as well as more data than can reasonably be stored for processing in conventional storage systems. Thus, it is nearly impossible for current computer systems to generate a report letter without human supervision. At the same time, human supervision cannot keep up with the pace of the huge amount of campaign delivery feeds data.

At least one of the databases in the database system may be a user database that stores information related to audience feeds related to a plurality of users. The user database may be affiliated with a data provider. The amount of audience feeds data may be greater than the amount of data of the corresponding campaign delivery feeds. The audience feeds may include all information related to a specific user from different data sources including: the publisher, the advertiser, or any other third parties such as a social network. For example, the record file may include personal information of the user, search histories of the user from the search engine 124, web browsing histories of the user from the content server 122, or any other information the user agreed to share with a data provider. Because the audience feeds may be created by different publishers on different platforms, the audience feeds may be marked differently across different publishers and platforms. That is, the data formats of the audience feeds may be so dissimilar as to severely complicate the data processing required of the conventional computer system. Thus, there is a need to develop a computer system, for instance including circuitry and program instructions to control the circuitry, and that can identify the human understandable information from the huge amount of audience feeds data.

The environment 100 may further include a plurality of devices 132, 134, and 136. The devices may be a computer, a smart phone, a personal digital aid, a digital reader, a Global Positioning System (GPS) receiver, or any other device that may be used to access the Internet.

The disclosed system and method for optimizing mobile campaigns may be implemented by the computing system 110. Alternatively or additionally, the system and method for optimizing mobile campaigns may be implemented by one or more of the servers in the server system 120. The disclosed system may instruct the devices 132, 134, and 136 to display one or more mobile ads in one or more mobile applications. The disclosed system may also instruct the devices 132, 134, and 136 to display information related to mobile application profiles.

Generally, an advertiser or any other user may use a computing device such as devices 132, 134, and 136 to access information on the server system 120 and the data in the database 150. The advertiser may want to learn the effectiveness of their ads. The typical setting is to preselect a set of users to see the ad (test) and another set of users to see a control ad placebo. However, for many different reasons, not everyone selected to see the ad will comply i.e. end up seeing the ad. The reasons for not seeing the ad can be correlated with the factors that impact the response to the ad e.g., a user who is on travel is less likely to complete a mortgage application form.

One way to address the above problem by comparing the response of the users who have seen the ads to the response of the users who could have seen the ad but ended up seeing the control or placebo ad. Since the decision to show a test or control ad is generally random, it will be uncorrelated with any user characteristics.

The first challenge with running the field experiments using placebo ads is that the advertiser still has to pay for all the ads whether they were test or control. While the cost can be somewhat reduced by using another advertiser as control, it is not often easy to line up two non-interacting advertisers. The second challenge with running the field experiments is that more and more of the advertising inventory is being sold on exchanges where the advertiser has to bid for every individual ad impression. Therefore, even if a user is assigned to the test group, there is no guarantee that the user will end up being exposed to the ad.

Furthermore, because the probability of winning an auction depends on the user's characteristics (for a fixed bid price), the treated users will be a non-randomly selected subset of the population that differs from the population. In other words, the actual treatment (user gets to see the ad impression) may be correlated with the unobserved variables that impact the user's response to the ad.

Accordingly, one of the technical problems solved by the disclosure is a lack of a robust and reliable system to measure the effectiveness of ads using the existing bidding exchanges. A new bidding system is provided that views the decision to bid (and the bid amount) on an ad impression as an intent to treat in the auction setting.

Further, the system solves technical problems presented by assigning a random bid amount to the bidding opportunity based on the at least one bidding parameters, where the random bid amount at least partially indicates a treatment intensity of the advertising message. Here, the treatment intensity at least partially indicates the amount of the treatment that a user receives. For example, the treatment intensity may indicate the number of impressions related to the advertising message. Alternatively or additionally, the treatment intensity may indicate the length of a video advertisement related to the advertising message.

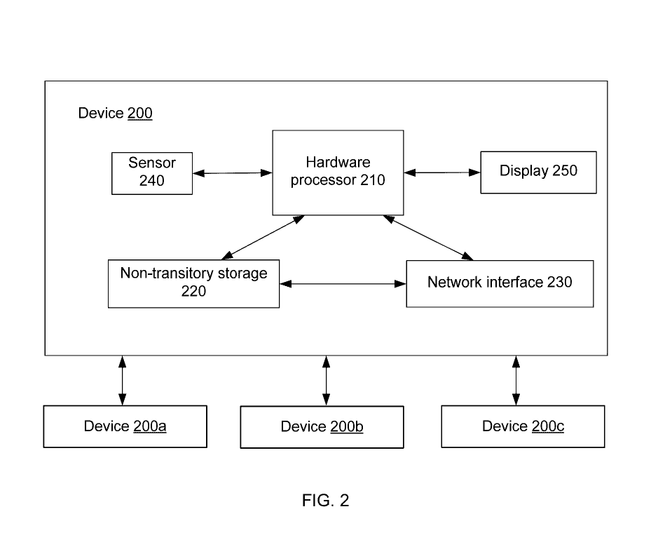

FIG. 2 illustrates an example computing device 200 for interacting with the advertiser. The computing device 200 may communicate with a computer server of the system. The computing device 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

The computing device 200 may display user interfaces on a display unit 250. For example, the computing device 200 may display a user interface on the display unit 250 asking the advertiser to input one or more identifications of a campaign. The user interface may provide checkboxes, dropdown selections or other types of graphical user interfaces for the advertiser to select geographical information, demographical information, mobile application information, technology information, publisher information, or other information related to an online campaign.

The computing device 200 may further display the advertising effectiveness for one or more ads. The computing device 200 may also display one or more drawings or figures that have different formats such as bar charts, pie charts, trend lines, area charts, etc. The drawings and figures may represent the advertising effectiveness or estimated advertising effectiveness for one or more ads.

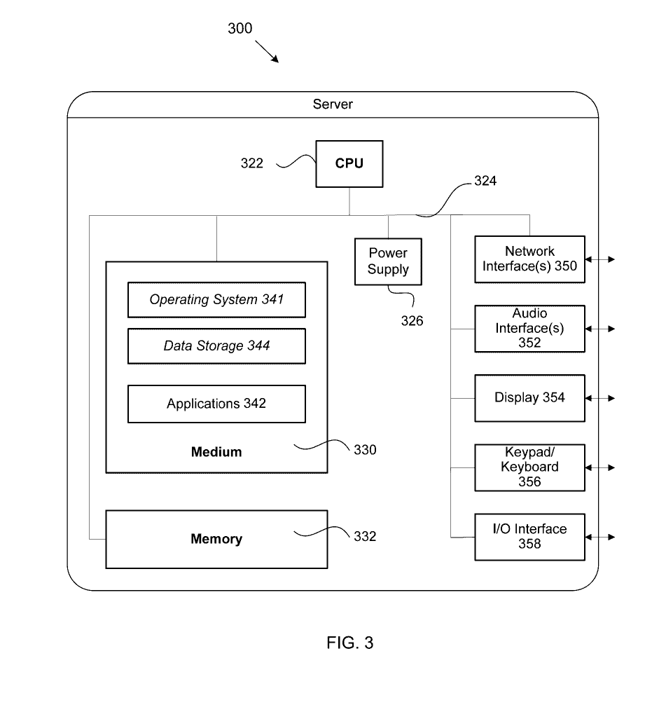

FIG. 3 is a schematic diagram illustrating an example embodiment of a server. A server 300 may include different hardware configurations or capabilities. For example, a server 300 may include one or more central processing units 322, memory 332 that is accessible to the one or more central processing units 322, one or more medium 330 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as any computer server shown in FIG. 1. The server 300 may also serve as a computer server that implements the computer system for optimizing mobile campaigns. In either case, the server 300 is in communication with a database that stores bidding data. The bidding data may include different bidding parameters for different audience segments at least partially based on search data, email data, page view data, TV data, mobile application data, social data, and etc. collected by different data providers. The database may also include creative landing uniform resource locator (URL), advertiser name, advertiser product, competitor information, campaign slogan, or other meta-data related to a campaign.

For example, the bidding parameters may include different parameters for different products or services related to at least one of the following: the age group of the audience, the income range of the audience, the geographical location of main residence, the spending range in a preset time period, the TV provider of the audience, and the number of friends in one or more social networks. These aspects may represent campaign features collected from search data, content data, email data, and social areas.

The database may further include user responses to one or more ads. For each advertising campaign, the user responses may include whether the user performed the desired action, which may include: clicking on a URL link, purchasing a product, downloading a mobile app, viewing a video, joining a program, etc. The advertiser may define any user responses before the campaign starts.

The server 300 is programmed to obtain a bidding opportunity to deliver a message from an exchange system, where the bidding opportunity includes an impression candidate and user information associated with the impression candidate.

For example, the server 300 may be programmed to obtain a bidding opportunity from a mobile device. The bidding opportunity may include user age range, user characteristics information, device identifications, mobile service provider, and other information available from the service provider. The bidding opportunity may further include a score at least partially based on the likelihood of the user to perform a desired action defined by the advertiser. In that case, the server 300 may then determine whether to bid on the bidding opportunity using the available information.

After receiving the mobile application data, the server 300 is programmed to obtain at least one bidding parameters from the database, where the at least one bidding parameters indicates a target audience of the message. The server 300 may obtain the at least one bidding parameters from the data in advance. For example, the server 300 may save the bidding parameters in a memory after it retrieves the bidding parameters from the database in the first time.

After generating mobile application profiles for a plurality of mobile apps, the server 300 is programmed to assign a random bid amount to the bidding opportunity based on the at least one bidding parameters, where the random bid amount at least partially indicates a treatment intensity of the message. The server may assign the random bid amount at least partially according to a random number generator. The server may multiply the maximum allowed amount to bid with the random number generated by the random number generator.

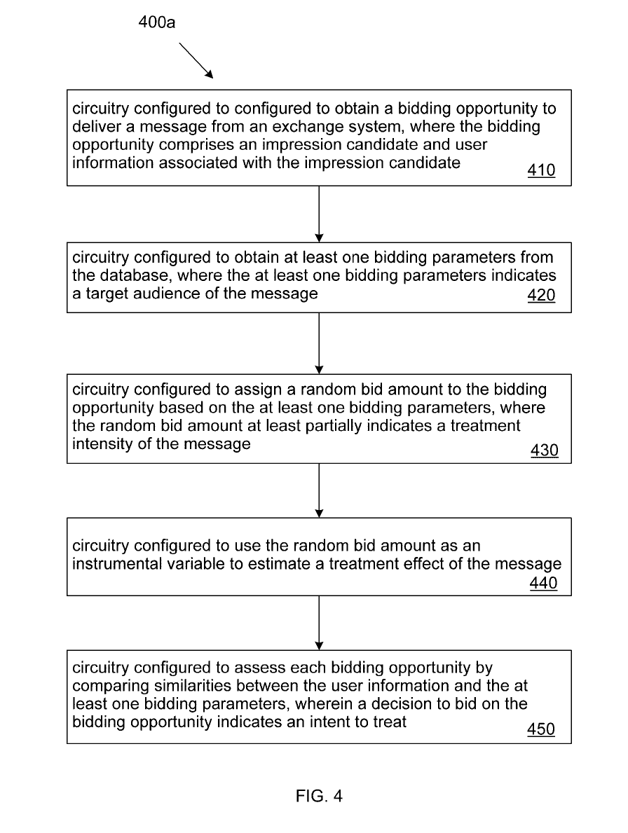

FIG. 4 illustrates embodiments of a block diagram 400a in the server 300 illustrated in FIG. 3. The block diagram 400a includes one or more circuitries. The one or more circuitries may include processors, integrated circuits, digital signal processors, or any other types of hardware, or a combination of software and hardware, for example. The block diagram 400a may include alternative, additional or fewer circuitries in other embodiments.

The block diagram 400a includes a circuitry 410 configured to obtain a bidding opportunity to deliver a message from an exchange system. The bidding opportunity may include an impression candidate and user information associated with the impression candidate. The circuitry 410 may obtain many impression candidates per second. Thus, the circuitry 410 needs to process the impression candidates in a real time or near real time fashion. Accordingly, the circuitry 410 may need to analyze each impression candidate and related user information and then determine whether to bid on the impression candidate in a very short period of time.

The block diagram 400a includes a circuitry 420 configured to obtain at least one bidding parameters from the database, where the at least one bidding parameters indicates a target audience of the message. The circuitry 420 may need to save the bidding parameters for different campaigns in a memory storage with access to the circuitry 420. The circuitry 420 may calculate a score at least partially based on the bidding parameters and the bidding opportunity, where the score may represent a likelihood of the user to perform the desired action if the user views the corresponding ad associated with the bidding parameters.

The block diagram 400a includes a circuitry 430 configured to assign a random bid amount to the bidding opportunity based on the at least one bidding parameters, where the random bid amount at least partially indicates a treatment intensity of the message. The circuitry 430 may assign the random bid amount according to a preset rule defined by the advertiser. For example, the circuitry 430 may select the random bid amount at least partially related to the likelihood of the user to perform the desired action.

The block diagram 400a includes a circuitry 440 configured to use the random bid amount as an instrumental variable to estimate a treatment effect of the message. The circuitry 440 may adopt instrumental variable regression to remove error in the measured variables, simultaneous causality bias, and omitted variable bias from unobserved variables. The treatment effect of the message may at least partially indicate the advertising effectiveness of the underlying advertisement message.

For example, let j denote the subject. Variables yⱼ, xⱼ, tⱼ respectively denote the response to ad, observed exogenous covariates, and treatment of subject j. The treatment tⱼ is not exogenous and may be correlated with the unobserved factors uⱼ that impact response. The idiosyncratic error eⱼ is i.i.d distributed and is not correlated with any of the other regressors. Here, the term “i.i.d” means that the random error variables are independent and identically distributed. The following equations may be used to describe the relations between the treatment and unobserved covariates.

yⱼ=βxⱼ+γtⱼ+uⱼ+eⱼ (1)

eⱼ˜N(0, σ₀²) (2)

corr(uⱼ, tⱼ)=ρ≠0 (3)

One way to overcome the omitted variable bias in Equation 1 is to use an instrumental variable approach. The intent to treat may be used as an instrument because it is correlated with the endogenous covariate tⱼ but is not correlated with the error uⱼ. In the ad exchange, the treatment tⱼ is correlated with the bid price.

For example, in the ad exchanges, the advertiser may need to bid a certain value for each user. Depending on the bid, the advertiser may either win the auction or loose the auction. If the advertiser wins the auction, the advertiser gets to display the corresponding ad to the user. The new system may therefore randomly vary the bid and use the bid price as an instrumental variable. Since the higher the bid the higher the probability of winning the auction, the bid price is correlated with the treatment. However, because the bid prices are random, they are not correlated with the unobserved user features. Equation 4 below shows how the bid price bid; can be used as an instrument for the treatment tⱼ.

tⱼ=δbidⱼ+e_{2,j} (4)

e_{2,j}˜N(0, σ₂²) (5)

The block diagram 400a may further include a circuitry 450 configured to assess each bidding opportunity by comparing similarities between the user information and the at least one bidding parameters, wherein a decision to bid on the bidding opportunity indicates an intent to treat. The circuitry 450 may determine whether to bid the opportunity or not at least partially based on similarities between the user information and the bidding parameters from the advertiser. The circuitry 450, however, may take into account other factors when determining whether to bid the opportunity.

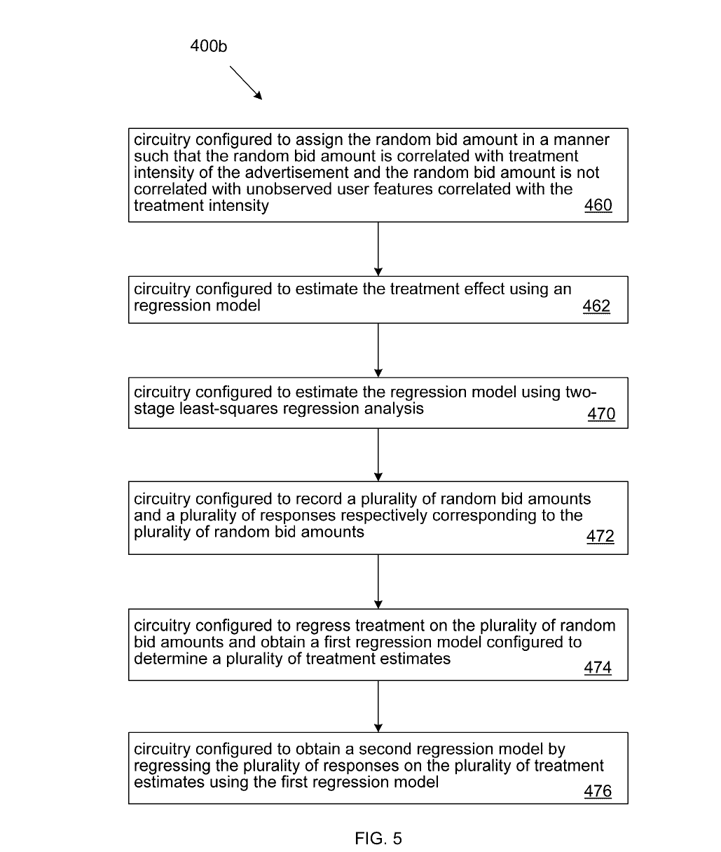

FIG. 5 illustrates embodiments of a block diagram 400b in the server 300 illustrated in FIG. 3. The block diagram 400b may further include a circuitry 460 configured to assign the random bid amount in a manner such that the random bid amount is correlated with treatment intensity of the advertisement and the random bid amount is not correlated with unobserved user features which are correlated with the treatment intensity. The circuitry 460 may assign the random bid amount using a random number generator independent from the user features. Here, the random bid amount is inherently correlated with the treatment intensity because a higher bid amount is more likely to win the bidding opportunity.

The block diagram 400b includes a circuitry 462 configured to estimate the treatment effect using a regression model. The regression model may include linear regression model and nonlinear regression model. The circuitry 462 may adopt different regression analyses including linear regression, ordinary least squares regression, and nonparametric regression.

The block diagram 400b includes a circuitry 470 configured to estimate the regression model using two-stage least-squares regression analysis. The circuitry 470 may estimate the regression model parameters using two-stage least-squares regression analysis. In ordinary least square (OLS) methods, there is a basic assumption that the value of the error terms is independent of predictor variables. When this assumption is broken in the current technical problem, the bidding system adopts the two-stage least-squares regression analysis to solve this problem. This analysis assumes that there is a secondary predictor that is correlated to the problematic predictor but not with the error term. Given the existence of the bid price as the instrumental variable, the following two stages are implemented in the bidding system. In the first stage, a new variable is created using the instrumental variable as in equation (4). In the second stage, the model-estimated values from the first stage are then used in place of the actual values of the problematic predictors to compute an OLS model for the response of interest.

The block diagram 400b includes a circuitry 472 configured to record a plurality of random bid amounts and a plurality of responses respectively corresponding to the plurality of random bid amounts. The circuitry 472 may record the bid amounts and the corresponding responses for opportunities from different publishers. The bid amounts may be configured to be a random amount less than a preset threshold. Alternatively, the bid amounts be configured in preset ranges including a lower bound and an upper bound.

The block diagram 400b may include a circuitry 474 configured to regress treatment on the plurality of random bid amounts and obtain a first regression model configured to determine a plurality of treatment estimates. The circuitry 474 may regress treatments on the plurality of random bid amounts and obtain a first linear regression model configured to determine a plurality of treatment estimates. The first linear regression model may be modeled using the equations (4) and (5). In other words, the computer system may regress the treatment which is endogenous on the instrumental variable, which is the bid price. For example, the explanatory variable tⱼ that is an endogenous covariate in equation (4) may be regressed on all of the exogenous variables in the model, including both exogenous covariates in the equation (4). The predicted treatment estimates tⱼ from these regressions are obtained in this stage and will be used in the second stage.

The block diagram 400b may include a circuitry 476 configured to obtain a second regression model by regressing the plurality of responses on the plurality of treatment estimates using the first regression model. The second regression model may be modeled using equations (1)-(3). The circuitry 476 may user maximum likelihood estimation, least square estimation, or any other estimation methods in the second stage. For example, the first and second regression models are characterized by unobserved scalar parameters configured to maximize likelihood functions according to the first and second regression models. Alternatively, the first and second regression models are characterized by unobserved scalar parameters configured to minimize least square errors according to the first and second regression models. In this stage, the regression of interest is estimated as usual, except that in this stage each endogenous covariate is replaced with the predicted values from the treatment estimates obtained by the circuitry 474.

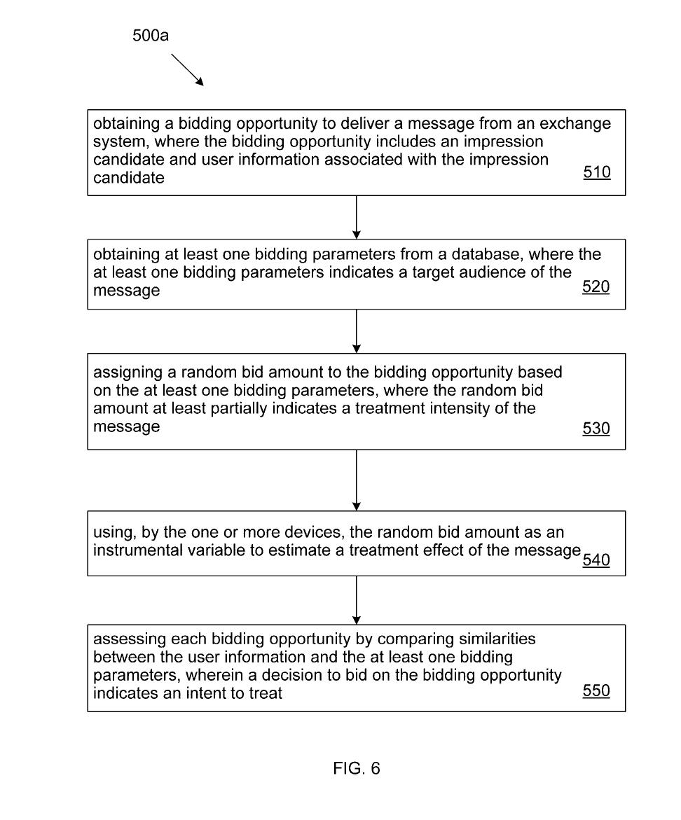

FIG. 6 is an example flow diagram 500a illustrating embodiments of the disclosure. The flow diagram 500a may be implemented at least partially by a computer system that includes a computer server 300 having a processor as illustrated in FIG. 3. The computer implemented method according to the example block diagram 500a includes the following acts. Other acts may be added or substituted.

In act 510, the computer system obtains a bidding opportunity to deliver a message from an exchange system, where the bidding opportunity includes an impression candidate and user information associated with the impression candidate. The message may include any information from an advertiser. The bidding opportunity may include advertising opportunity on different platforms including: online ads on computers, mobile ads on mobile devices, and ads on other type of devices. The user information may include age, gender, interests, social network properties, and any other information the user agreed to share with a publisher.

In act 520, the computer system obtains at least one bidding parameters from a database, where the at least one bidding parameters indicates a target audience of the message. The computer system may need to work around the clock and process the bidding opportunities in real time or near real time. The computer system may need to process millions of requests per minute. The computer system may also need to access the database to obtain the bidding parameters preset by an advertiser or another computer system accessible to the advertiser.

In act 530, the computer system assigns a random bid amount to the bidding opportunity based on the at least one bidding parameters, where the random bid amount at least partially indicates a treatment intensity of the message. The computer system may. The computer system may use any random number generators to generate the random bid amount in a range approved by the advertiser.

In act 540, the computer system uses the random bid amount as an instrumental variable to estimate a treatment effect of the message. The computer system may record a plurality of random bid amounts selected in act 530 and the corresponding user reactions. The computer system may then adopt the random bid amounts as an instrumental variable to estimate the causal relationship between the treatment and the advertising effectiveness.

In act 550, the computer system assesses each bidding opportunity by comparing similarities between the user information and the at least one bidding parameters, where a decision to bid on the bidding opportunity indicates an intent to treat. The computer system may calculate cores to measure the similarities between the user information and the at least one bidding parameters. The computer system may then determine to bid at least partially based on the calculated score. Here, the decision to bid on the bidding opportunity indicates an intent to treat by the advertiser.

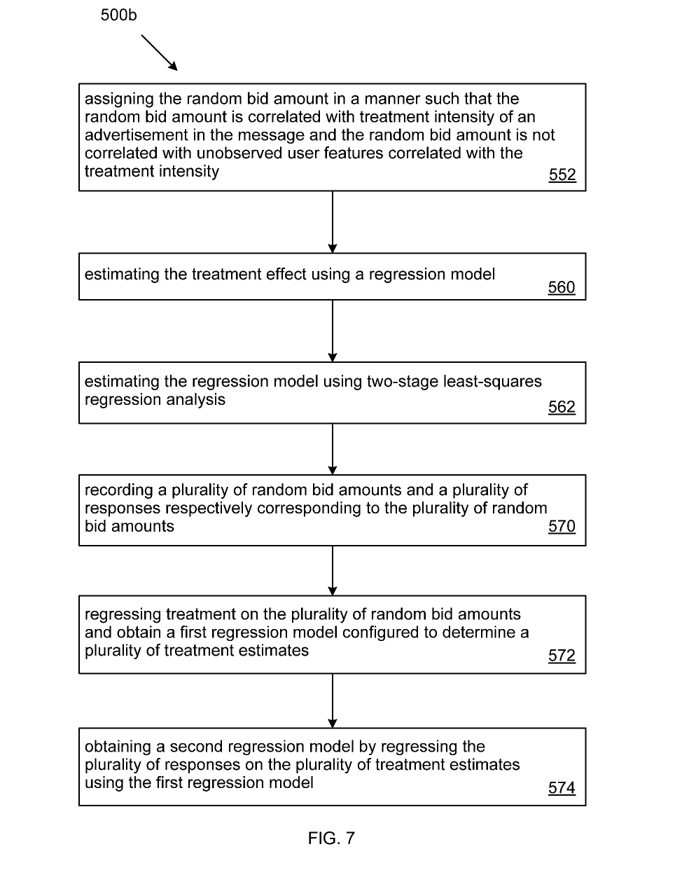

FIG. 7 is an example flow diagram 500b illustrating embodiments of the disclosure. The acts in the example flow diagram 500b may be combined with the acts in the flow diagram 500a shown in FIG. 6. Similarly, the acts in the example flow diagram 500b may be implemented at least partially by a computer system that includes a server computer 300 disclosed in FIG. 3. The computer implemented method according to the example flow diagram 500b includes the following acts. Other acts may be added or substituted.

In act 552, the computer system assigns the random bid amount in a manner such that the random bid amount is correlated with treatment intensity of an advertisement in the message and the random bid amount is not correlated with unobserved user features correlated with the treatment intensity. The computer system may assign the bid amount randomly using a random number generator independent from any user feature. Thus, the computer system can assure that the random bid amount is not correlated with any user feature.

In act 560, the computer system estimates the treatment effect using a regression model. The computer system may use a linear regression model or other regression models. The advertising effectiveness may be at least partially represented by the estimate of y in equation (1). The computer system will not use tⱼ but rather the fitted value from equations 4-5 in the regression model.

In act 562, the computer system estimates the regression model using two-stage least-squares regression analysis. The computer system may use least-square regressions to estimate model parameters in equations (1) and (4) above.

In act 570, the computer system may record a plurality of random bid amounts and a plurality of responses respectively corresponding to the plurality of random bid amounts. The computer system may record the responses according to advertiser choices, which represent whether the response is desired or not. The advertiser may also request the computer system to assign different weights to different responses.

In act 572, the computer system may regress treatment on the plurality of random bid amounts and obtain a first regression model configured to determine a plurality of treatment estimates. The first regression model may be at least partially related to equations (4)-(5).

In act 574, the computer system may obtain a second regression model by regressing the plurality of responses on the plurality of treatment estimates using the first regression model. The second regression model may be at least partially related to equations (1)-(3). The computer system may adopt the first and second regression models which are characterized by unobserved scalar parameters configured to maximize likelihood functions according to the first and second regression models.

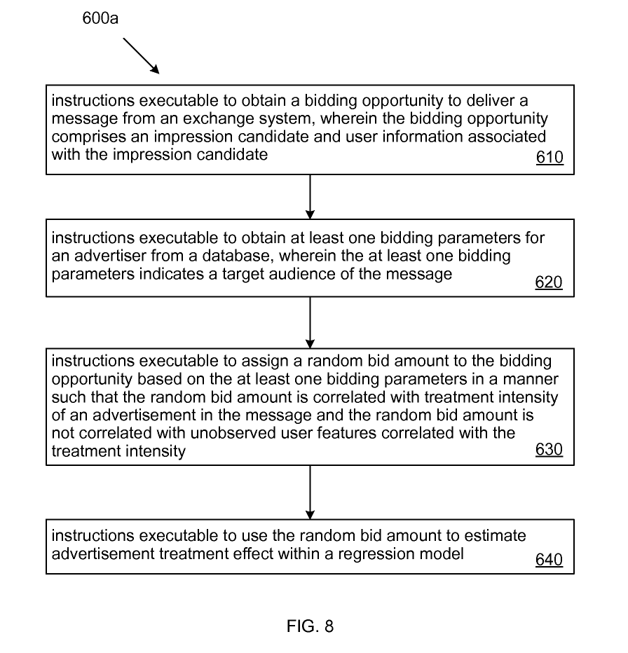

FIG. 8 is an example block diagram illustrating a non-transitory storage medium 600a of the disclosure. The non-transitory storage medium 600a may be programmed to store instructions to be executable by a computer system described above.

The non-transitory storage medium 600a may include instructions 610 executable to obtain a bidding opportunity to deliver a message from an exchange system, wherein the bidding opportunity comprises an impression candidate and user information associated with the impression candidate. The non-transitory storage medium 600a may include instructions 620 instructions executable to obtain at least one bidding parameters for an advertiser from a database, wherein the at least one bidding parameters indicates a target audience of the message.

The non-transitory storage medium 600a may include instructions 630 instructions executable to assign a random bid amount to the bidding opportunity based on the at least one bidding parameters in a manner such that the random bid amount is correlated with treatment intensity of an advertisement in the message and the random bid amount is not correlated with unobserved user features correlated with the treatment intensity. The non-transitory storage medium 600a may include instructions 640 instructions executable to use the random bid amount to estimate advertisement treatment effect within a regression model.

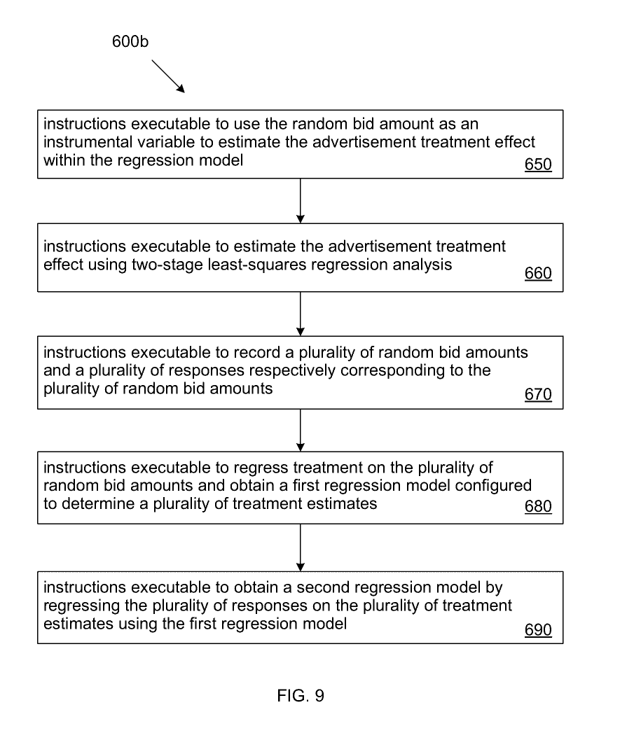

FIG. 9 is an example block diagram illustrating a non-transitory storage medium 600b of the disclosure. The non-transitory storage medium 600b may be combined with the non-transitory storage medium 600a to store instructions to be executable by a computer system described above.

The non-transitory storage medium 600b may include instructions 650 executable to use the random bid amount as an instrumental variable to estimate the advertisement treatment effect within the regression model. The non-transitory storage medium 600b may include instructions 660 executable to instructions executable to estimate the advertisement treatment effect using two-stage least-squares regression analysis.

The non-transitory storage medium 600b may include instructions 670 executable to record a plurality of random bid amounts and a plurality of responses respectively corresponding to the plurality of random bid amounts.

The non-transitory storage medium 600b may include instructions 680 executable to regress treatment on the plurality of random bid amounts and obtain a first regression model configured to determine a plurality of treatment estimates.

The non-transitory storage medium 600b may include instructions 690 executable to obtain a second regression model by regressing the plurality of responses on the plurality of treatment estimates using the first regression model. The first and second regression models are characterized by unobserved scalar parameters configured to maximize likelihood functions according to the first and second regression models. The likelihood functions may include a natural logarithm of the likelihood function to be used in a maximum likelihood estimation.

The disclosed computer implemented method may be stored in computer-readable storage medium. The computer-readable storage medium is accessible to at least one hardware processor. The processor is configured to implement the stored instructions to measure advertising effectiveness in advertising ex-change systems.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

From the foregoing, it can be seen that the present embodiments provide a computer system that measures the advertising effectiveness in advertising exchange systems using regressions. The computer system provides a solution that does not require showing placebo ads to the control group. Further, the computer system removes the potential correlation effect between the actual treatment and the unobserved variables that impact the users response to the advertisement.

It is therefore intended that the foregoing detailed description be regarded as illustrative rather than limiting, and that it be understood that it is the following claims, including all equivalents, that are intended to define the spirit and scope of this invention.

What is claimed is:

1. A bidding system comprising:
a processor and a non-transitory storage medium accessible to the processor;
a memory storing a database comprising bidding parameters;
a computer server in communication with the memory and the database, the computer server comprising:
circuitry configured to obtain a bidding opportunity to deliver a message from an exchange system, wherein the bidding opportunity comprises an impression candidate and user information associated with the impression candidate;
circuitry configured to obtain at least one bidding parameters from the database, wherein the at least one bidding parameters indicates a target audience of the message; and
circuitry configured to assign a random bid amount to the bidding opportunity based on the at least one bidding parameters, wherein the random bid amount at least partially indicates a treatment intensity of the message.

2. The bidding system of claim 1, further comprising:
circuitry configured to use the random bid amount as an instrumental variable to estimate a treatment effect of the message.

3. The bidding system of claim 1, further comprising:
circuitry configured to assess each bidding opportunity by comparing similarities between the user information and the at least one bidding parameters, wherein a decision to bid on the bidding opportunity indicates an intent to treat.

4. The bidding system of claim 1, wherein the message comprises an advertisement; and wherein the computer server further comprises circuitry configured to assign the random bid amount in a manner such that the random bid amount is correlated with treatment intensity of the advertisement and the random bid amount is not correlated with unobserved user features correlated with the treatment intensity.

5. The bidding system of claim 2, further comprising:
circuitry configured to estimate the treatment effect using a regression model.

6. The bidding system of claim 5, wherein the computer further comprises circuitry configured to estimate the regression model using two-stage least-squares regression analysis.

7. The bidding system of claim 1, wherein the computer server further comprises circuitry configured to record a plurality of random bid amounts and a plurality of responses respectively corresponding to the plurality of random bid amounts.

8. The bidding system of claim 7, further comprising:
circuitry configured to regress treatment on the plurality of random bid amounts and obtain a first regression model configured to determine a plurality of treatment estimates; and
circuitry configured to obtain a second regression model by regressing the plurality of responses on the plurality of treatment estimates using the first regression model,
wherein the first and second regression models are characterized by unobserved scalar parameters configured to maximize likelihood functions according to the first and second regression models.

9. A method, comprising:
obtaining, by one or more devices having a processor, a bidding opportunity to deliver a message from an exchange system, wherein the bidding opportunity comprises an impression candidate and user information associated with the impression candidate;
obtaining, by the one or more devices, at least one bidding parameters from a database, wherein the at least one bidding parameters indicates a target audience of the message; and
assigning, by the one or more devices, a random bid amount to the bidding opportunity based on the at least one bidding parameters, wherein the random bid amount at least partially indicates a treatment intensity of the message.

10. The method of claim 9, further comprising:
using, by the one or more devices, the random bid amount as an instrumental variable to estimate a treatment effect of the message.

11. The method of claim 9, further comprising:
assessing each bidding opportunity by comparing similarities between the user information and the at least one bidding parameters, wherein a decision to bid on the bidding opportunity indicates an intent to treat.

12. The method of claim 9, further comprising:
assigning the random bid amount in a manner such that the random bid amount is correlated with treatment intensity of an advertisement in the message and the random bid amount is not correlated with unobserved user features correlated with the treatment intensity.

13. The method of claim 10, further comprising:
estimating the treatment effect using a regression model.

14. The method of claim 13, further comprising:
estimating the regression model using two-stage least-squares regression analysis.

15. The method of claim 9, further comprising:
recording a plurality of random bid amounts and a plurality of responses respectively corresponding to the plurality of random bid amounts.

16. The method of claim 15, further comprising:
regressing treatment on the plurality of random bid amounts and obtain a first regression model configured to determine a plurality of treatment estimates; and
obtaining a second regression model by regressing the plurality of responses on the plurality of treatment estimates using the first regression model,
wherein the first and second regression models are characterized by unobserved scalar parameters configured to maximize likelihood functions according to the first and second regression models.

17. A non-transitory storage medium, comprising:
instructions executable to obtain a bidding opportunity to deliver a message from an exchange system, wherein the bidding opportunity comprises an impression candidate and user information associated with the impression candidate;
instructions executable to obtain at least one bidding parameters for an advertiser from a database, wherein the at least one bidding parameters indicates a target audience of the message;
instructions executable to assign a random bid amount to the bidding opportunity based on the at least one bidding parameters in a manner such that the random bid amount is correlated with treatment intensity of an advertisement in the message and the random bid amount is not correlated with unobserved user features correlated with the treatment intensity; and
instructions executable to use the random bid amount to estimate advertisement treatment effect within a regression model.

18. The non-transitory storage medium of claim 17, further comprising:
instructions executable to use the random bid amount as an instrumental variable to estimate the advertisement treatment effect within the regression model; and
instructions executable to estimate the advertisement treatment effect using two-stage least-squares regression analysis.

19. The non-transitory storage medium of claim 17, further comprising:
instructions executable to record a plurality of random bid amounts and a plurality of responses respectively corresponding to the plurality of random bid amounts.

20. The non-transitory storage medium of claim 19, further comprising:
instructions executable to regress treatment on the plurality of random bid amounts and obtain a first regression model configured to determine a plurality of treatment estimates; and
instructions executable to obtain a second regression model by regressing the plurality of responses on the plurality of treatment estimates using the first regression model;
wherein the first and second regression models are characterized by unobserved scalar parameters configured to maximize likelihood functions according to the first and second regression models.
